(19) United States
(12) Patent Application Publication
(10) Pub. No.: US 2017/0032328 A1
(43) Pub. Date: Feb. 2, 2017

(54) SERVER, CONTROL METHOD FOR SERVER, AND NON-TRANSITORY COMPUTER-READABLE STORAGE MEDIUM STORING COMPUTER PROGRAM FOR SERVER

(71) Applicant: GURUNAVI, INC., Tokyo (JP)

(72) Inventor: Atsushi YAMADA, Yokohama-shi (JP)

(73) Assignee: GURUNAVI, INC., Tokyo (JP)

(21) Appl. No.: 15/216,801

(22) Filed: Jul. 22, 2016

(30) Foreign Application Priority Data
Jul. 31, 2015 (JP) 2015-152701

(51) Int. Cl. G06Q 10/10

(52) U.S. Cl. CPC G06Q 10/1095

(57) ABSTRACT

A control method including; accepting a setting of a plurality of convened users who are convened to attend an event and a setting of a plurality of candidate dates and times of the event from an organizer terminal of an organizing user; reading the schedule data corresponding to the plurality of candidate dates and times from the storage unit for each of the plurality of convened users; and outputting page information to user terminals of the plurality of convened users, the page information being information for displaying, on the user terminals of the plurality of convened users, a page containing the plurality of candidate dates and times such that the candidate dates and times at which the number of convened users having plans is small and the candidate dates and times at which the number of convened users having plans is large are in distinction from each other.

### INCORPORATION BY REFERENCE

The disclosure of Japanese Patent Application No. 2015-152701 filed on Jul. 31, 2015 including the specification, drawings and abstract is incorporated herein by reference in its entirety.

### BACKGROUND OF THE INVENTION

1. Field of the Invention

The invention relates to a server, a control method for a server, and a non-transitory computer-readable storage medium storing a control program for a server.

2. Description of Related Art

Conventionally, an organizing user who holds an event individually provides information about a plurality of candidate dates and times to a plurality of convened users who are convened to attend the event, and fixes a date and time for holding the event on the basis of attendance replies individually received from the convened users for each of the plurality of candidate dates and times.

For example, Japanese Patent Application Publication No. 2005-4307 (JP 2005-004307 A) describes a schedule management support system by which an organizer selects a final candidate date and time from among a plurality of candidate dates and times included in an appointment.

### SUMMARY OF THE INVENTION

The schedule management support system described in JP 2005-004307 A merely displays the plurality of candidate dates and times included in the appointment on a calendar of each convened user regardless of the schedules of the other convened users. Therefore, even when each convened user views the plurality of candidate dates and times displayed on his or her own calendar, the convened user is not allowed to obtain grounds for determining which candidate date and time is a major candidate among the plurality of candidate dates and times.

However, if each convened user is allowed to estimate at which one of the plurality of candidate dates and times the event is highly likely to actually take place, the schedule management support system allows each convened user to get an opportunity to review his or her own plans at the plurality of candidate dates and times and then to adjust his or her schedules.

The invention provides a server that allows each convened user to estimate which one of a plurality of candidate dates and times is a major candidate, a control method for the server, and a non-transitory computer-readable storage medium storing a control program for the server.

A first aspect of the invention provides a control method for a server including a storage unit. The control method includes: storing schedule data in the storage unit, the schedule data indicating plans of each of a plurality of users; accepting a setting of a plurality of convened users who are convened to attend an event and a setting of a plurality of candidate dates and times of the event from an organizer terminal of an organizing user who is one of the plurality of users; reading the schedule data corresponding to the plurality of candidate dates and times from the storage unit for each of the plurality of convened users; and outputting page information to user terminals of the plurality of convened users, the page information being information for displaying, on the user terminals of the plurality of convened users, a page containing the plurality of candidate dates and times such that the candidate dates and times at which the number of convened users having plans is small and the candidate dates and times at which the number of convened users having plans is large are in distinction from each other. With the control method for a server according to the first aspect of the invention, a page, containing the plurality of candidate dates and times such that the candidate dates and times at which the number of convened users having plans is small and the candidate dates and times at which the number of convened users having plans is large are in distinction from each other, is displayed on the user terminals of the plurality of convened users, each convened user is allowed to estimate a major candidate among a plurality of candidate dates and times.

In the above aspect, the control method may further include accepting a setting of candidate dates and times, at which the convened user can attend, from the user terminal of the convened user, which has received the output page information. According to this aspect, the server is allowed to distinguish the candidate dates and times, at which the convened user can attend, from the other candidate dates and times.

In the above aspect, the control method may further include generating second page information on the basis of the setting of the candidate dates and times, at which the convened user can attend, the second page information being information for displaying the candidate dates and times such that the candidate dates and times, at which the convened user can attend, and the other candidate dates and times are in distinction from each other; and outputting the second page information instead of the page information to the user terminal of the convened user, which has transmitted a request, in response to the request from the user terminal of the convened user. According to this aspect, the user terminal of each convened user is allowed to display a page on which the candidate dates and times, at which the convened user can attend, and the other candidate dates and times are in distinction from each other.

In the above-aspect, the control method may further include generating the page information on the basis of the setting of the candidate dates and times at which the convened user can attend, the page information being information for displaying attendance information of the convened user at the corresponding candidate date and time at the same time. According to this aspect, the user terminal of each convened user is allowed to display a page that allows comparison of the candidate dates and times at which the convened user can attend with the candidate dates and times at which the number of convened users having plans is small and the candidate dates and times at which the number of convened users having plans is large.

In the above aspect, the control method may further include compiling the number of convened users who can attend for each of the plurality of candidate dates and times of the event; and outputting, to the organizer terminal, the compiled number of convened users who can attend for each of the plurality of candidate dates and times of the event. According to this aspect, the organizer terminal is allowed to display a page containing the number of convened users who can attend for each of the plurality of candidate dates and times of the event.

In the above aspect, the control method may further include accepting a setting of a date and time for holding the event from the organizer terminal; and outputting third page information to the user terminals of the plurality of convened users, the third page information being information for selecting whether to actually attend the event at the date and time for holding the event. According to this aspect, the user terminal of each of the plurality of convened users is allowed to display a page for selecting whether to actually attend the event at the holding date and time.

In the above aspect, the control method may further include accepting a setting of attendance information from the user terminal of the convened user, which has received the third page information; and storing the attendance information in the storage unit in association with the convened user. According to this aspect, the server is allowed to store the attendance information associated with each convened user.

In the above aspect, the control method may further include compiling the number of users who have fixed attendance for each of the plurality of candidate dates and times of the event; and outputting, to the organizing terminal, the compiled number of users who attend and the compiled number of users who do not attend for each of the plurality of candidate dates and times of the event. According to this aspect, the organizer terminal is allowed to display a page containing the number of users who attend and the number of convened users who do not attend for each of the plurality of candidate dates and times of the event.

A second aspect of the invention provides a server. The server includes: a storage unit that stores schedule data indicating plans of each of a plurality of users; an accepting unit that accepts a setting of a plurality of convened users who are convened to attend an event and a setting of a plurality of candidate dates and times of the event from an organizer terminal of an organizing user who is one of the plurality of users; a reading unit that reads the schedule data corresponding to the plurality of candidate dates and times from the storage unit for each of the plurality of convened users; and an output unit that outputs page information to user terminals of the plurality of convened users, the page information being information for displaying, on the user terminals of the plurality of convened users, a page containing the plurality of candidate dates and times such that the candidate dates and times at which the number of convened users having plans is small and the candidate dates and times at which the number of convened users having plans is large are in distinction from each other. With the server according to the second aspect of the invention, a page, containing the plurality of candidate dates and times such that the candidate dates and times at which the number of convened users having plans is small and the candidate dates and times at which the number of convened users having plans is large are in distinction from each other, is displayed on the user terminals of the plurality of convened users, each convened user is allowed to estimate a major candidate among a plurality of candidate dates and times.

A third aspect of the invention provides a non-transitory computer-readable storage medium storing a control program for a server including a storage unit, the control program causing the server to execute instructions for: storing schedule data in the storage unit, the schedule data indicating plans of each of a plurality of users; accepting a setting of a plurality of convened users who are convened to attend an event and a setting of a plurality of candidate dates and times of the event from an organizer terminal of an organizing user who is one of the plurality of users; reading the schedule data corresponding to the plurality of candidate dates and times from the storage unit for each of the plurality of convened users; and outputting page information to user terminals of the plurality of convened users, the page information being information for displaying, on the user terminals of the plurality of convened users, a page containing the plurality of candidate dates and times such that the candidate dates and times at which the number of convened users having plans is small and the candidate dates and times at which the number of convened users having plans is large are in distinction from each other. With the non-transitory computer-readable storage medium storing the control program for a server according to the third aspect of the invention, a page, containing the plurality of candidate dates and times such that the candidate dates and times at which the number of convened users having plans is small and the candidate dates and times at which the number of convened users having plans is large are in distinction from each other, is displayed on the user terminals of the plurality of convened users, each convened user is allowed to estimate a major candidate among a plurality of candidate dates and times.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view for illustrating the outline of a schedule management system;

FIG. 2 is a schematic view for illustrating the outline of the schedule management system;

FIG. 3 is a view that shows an example of the schematic configuration of the schedule management system;

FIG. 4A is a view that shows an example of the schematic configuration of an organizer terminal;

FIG. 4B is a view that shows an example of the schematic configuration of a user terminal;

FIG. 5 is a view that shows an example of the schematic configuration of a server;

FIG. 6A to FIG. 6C are views that show examples of the data structures of tables;

FIG. 7A and FIG. 7B are views that show examples of the data structures of other tables;

FIG. 8 is a view that shows an example of the operation sequence of the process of determining candidate dates and times by the schedule management system;

FIG. 9 is a view that shows an example of the operation sequence of the process of determining a date and time for holding an event by the schedule management system;

FIG. 10A is a view that shows an example of a page that is displayed on the organizer terminal;

FIG. 10B is a view that shows an example of a page that is displayed on the user terminal;

FIG. 11A to FIG. 11C are views that show examples of pages that are displayed on the user terminal;

FIG. 12A is a view that shows an example of a page that is displayed on the organizer terminal;

FIG. 12B is a view that shows an example of a page that is displayed on the user terminal;

FIG. 13A and FIG. 13B are views that show examples of a page that is displayed on the user terminal;

FIG. 14 is a view that shows an example of a page that is displayed on the organizer terminal;

FIG. 15 is a view that shows an example of a page that is displayed on the user terminal; and

FIG. 16 is a view that shows an example of a page that is displayed on the organizer terminal.

### DETAILED DESCRIPTION OF EMBODIMENTS

Hereinafter, various embodiments of the invention will be described with reference to the accompanying drawings. It should be noted that the technical scope of the invention is not limited to those embodiments and encompasses the invention recited in the appended clams and equivalents thereof.

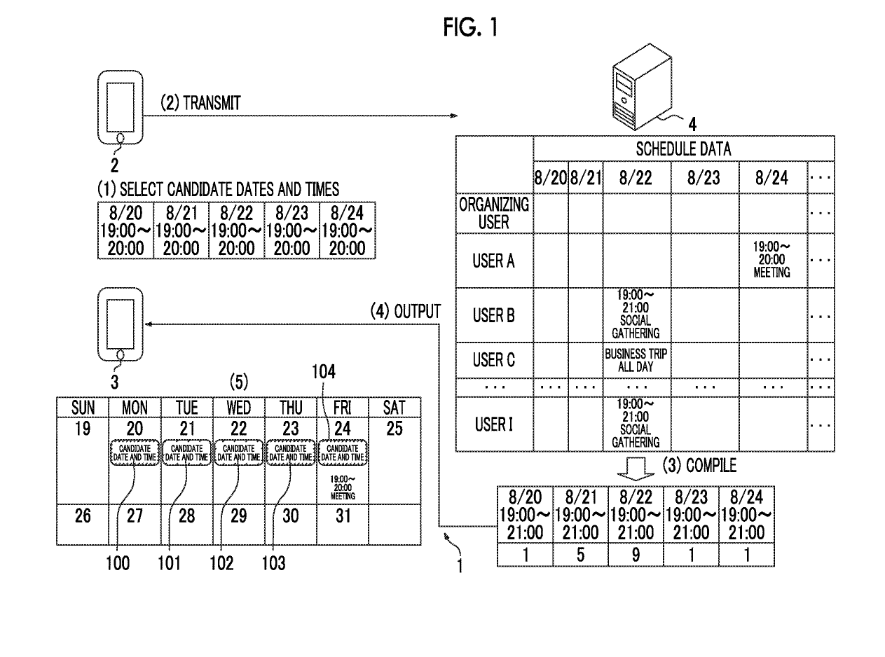

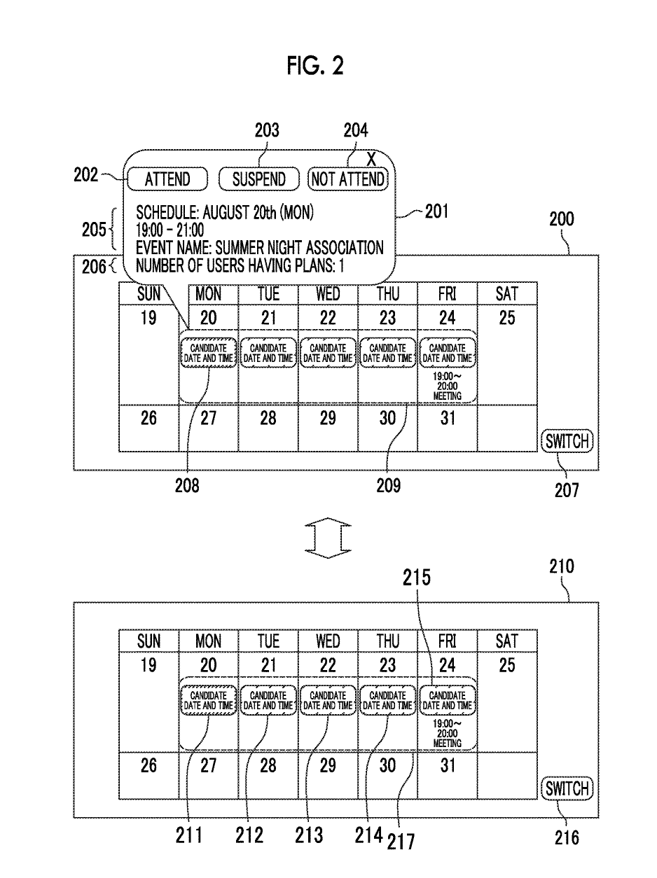

FIG. 1 and FIG. 2 are schematic views for illustrating the outline of a schedule management system 1.

FIG. 1 is a schematic view for illustrating in outline a case where a schedule page that shows a plurality of candidate dates and times is displayed. The schedule management system 1 includes an organizer terminal 2, user terminals 3, a server 4, and the like. The server 4 includes a storage unit, or the like, that stores schedule data indicating plans of each of a plurality of users.

In response to an operation conducted by an organizing user, the organizer terminal 2 selects a plurality of convened users who are convened to attend an event and a plurality of candidate dates and times of the event (1). The organizer terminal 2 transmits the plurality of selected convened users and the plurality of selected candidate dates and times to the server 4 (2).

As the server 4 receives the plurality of convened users and the plurality of candidate dates and times from the organizer terminal 2, the server 4 accepts the setting of the plurality of convened users and the setting of the plurality of candidate dates and times. The server 4 reads the schedule data corresponding to the plurality of candidate dates and times from the storage unit for each of the plurality of convened users, and compiles the number of convened users having plans for each of the plurality of candidate dates and times (3).

The server 4 generates schedule page information on the basis of the compiled number of convened users having plans. The schedule page information is data for displaying the plurality of candidate dates and times on a page such that candidate dates and times at which the number of convened users having plans is small and candidate dates and times at which the number of convened users having plans is large are in distinction from each other. The schedule page information contains a display property that specifies the color, font, size, or the like, of text for each candidate date and time.

For example, it is assumed that the number of convened users having plans is one on August 20th, five on August 21st, nine on August 22nd, one on August 23rd and one on August 24th. In this case, because the numbers of convened users having plans on August 20th, August 23rd, and August 24th are small, the server 4 specifies the display properties of candidate dates and times 100, 103, 104 of August 20th, August 23rd, and August 24th such that the candidate dates and times 100, 103, 104 of August 20th, August 23rd, and August 24th are highlighted (for example, displayed in deep red). Because the number of convened users having plans on August 21st is not large or small, the server 4 specifies the display property of a candidate date and time 101 of August 21st such that the candidate date and time 101 of August 21st is not highlighted (for example, displayed in red that is not deep or light). Because the number of convened users having plans on August 22nd is large, the server 4 specifies the display property of a candidate date and time 102 of August 22nd such that the candidate date and time 102 of August 22nd is inconspicuously displayed (for example, displayed in light red). In this way, the server 4 generates schedule page information containing the display property specified for each candidate date and time.

The server 4 outputs the generated schedule page information to the user terminals 3 of the convened users (4). As the user terminal 3 receives the schedule page information from the server 4, the user terminal 3 displays a schedule page on the basis of the received schedule page information (5).

In this way, the user terminal 3 that has received the schedule page information from the server 4 is able to display the candidate dates and times distinctly step-by-step (gradationally) on the basis of the numbers of convened users having plans. Therefore, each convened user is allowed to estimate a major candidate among the plurality of candidate dates and times displayed on the user terminal 3.

FIG. 2 is a schematic view for illustrating in outline a case where the page is switched from a schedule page 200 to an attendance page 210.

The schedule page 200 is a page that displays candidate dates and times such that the candidate dates and times at which the number of convened users having plans is small and the candidate dates and times at which the number of convened users having plans is large are in distinction from each other. The attendance page 210 is a page that displays candidate dates and times such that the candidate dates and times at which the convened user can attend and the other candidate dates and times are in distinction from each other.

It is assumed that the user terminal 3 is displaying the schedule page 200. On the schedule page 200, candidate date and time icons are displayed in a plan display area 209 of all the candidate dates and times set by the organizing user.

As the candidate date and time icon 208 displayed in the plan display area 209 for August 20th is specified by the convened user, the user terminal 3 displays an attendance setting window 201 for the specified candidate date and time icon 208. An attend button 202, a suspend button 203, a not-attend button 204, event information 205, and the number 206 of convened users having plans at the candidate date and time are displayed on the attendance setting window 201.

As the attend button 202 is depressed by the convened user, the user terminal 3 transmits the date and time corresponding to the candidate date and time icon 208 to the server 4 as the candidate date and time at which the convened user can attend. As the server 4 receives the candidate date and time, at which the convened user can attend, from the user terminal 3, the server 4 accepts the setting of the candidate date and time at which the convened user can attend.

Subsequently, as a switch button 207 is depressed by the convened user, the server 4 generates attendance page information on the basis of the candidate date and time at which the convened user can attend and that has been accepted from the user terminal 3. For example, it is assumed that the candidate date and time of August 20th is set as the candidate date and time at which the convened user can attend and the candidate dates and times of August 21st to August 24th are not set as the candidate date and time at which the convened user can attend. In this case, the server 4 specifies the display property of a candidate date and time icon 211 displayed in a plan display area 217 of August 20th such that the candidate date and time icon 211 is highlighted (for example, displayed in deep red), and specifies the display properties of the other candidate date and time icons 212 to 215 such that the other candidate date and time icons 212 to 215 are inconspicuous. In this way, the server 4 generates attendance page information containing the display property specified for each candidate date and time.

The server 4 outputs the generated attendance page information to the user terminal 3 of the convened user. As the user terminal 3 receives the attendance page information from the server 4, the user terminal 3 displays the attendance page 210 on the basis of the received attendance page information. On the attendance page 210, the candidate date and time icons 211 to 215 are displayed in the plan display area 217 of all the candidate dates and times set by the organizing user.

In this way, the server 4 is configured to be able to switch to output the schedule page information or the attendance page information. The schedule page information is information for displaying the candidate dates and times distinctly step-by-step on the basis of the number of convened users having plans. The attendance page information is information for displaying the candidate date and times such that the candidate dates and times at which the convened user can attend and the other candidate dates and times are in distinction from each other. Therefore, the convened user is allowed to easily compare the number of convened users having plans with the candidate dates and times at which the convened user can attend.

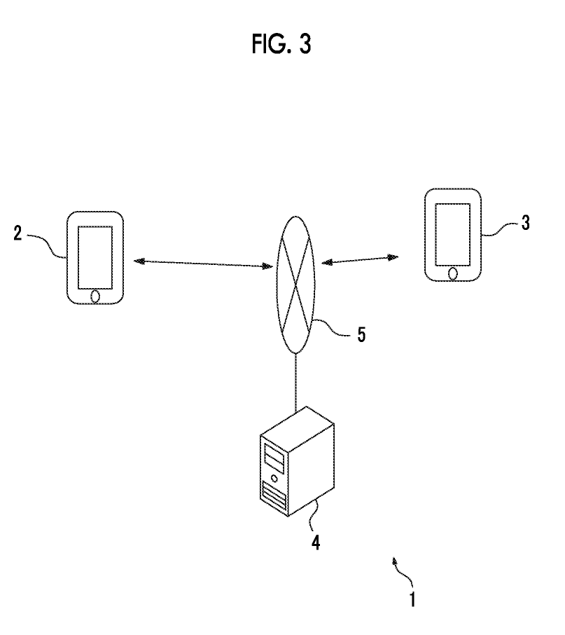

FIG. 3 is a view that shows an example of the schematic configuration of the schedule management system 1.

The schedule management system 1 includes the organizer terminal 2, the user terminal 3 and the server 4. The organizer terminal 2 and the server 4 are connected to each other via a communication network, and are connected to each other via, for example, the Internet 5. A program that is executed in the organizer terminal 2 and a program that is executed in the server 4 communicate with each other with the use of a communication protocol, such as hypertext transfer protocol (HTTP). The user terminal 3 and the server 4 are connected to each other via a communication network, and are connected to each other via, for example, the Internet 5. A program that is executed in the user terminal 3 and a program that is executed in the server 4 communicate with each other with the use of a communication protocol, such as hypertext transfer protocol. The schedule management system 1 may include a plurality of the user terminals 3.

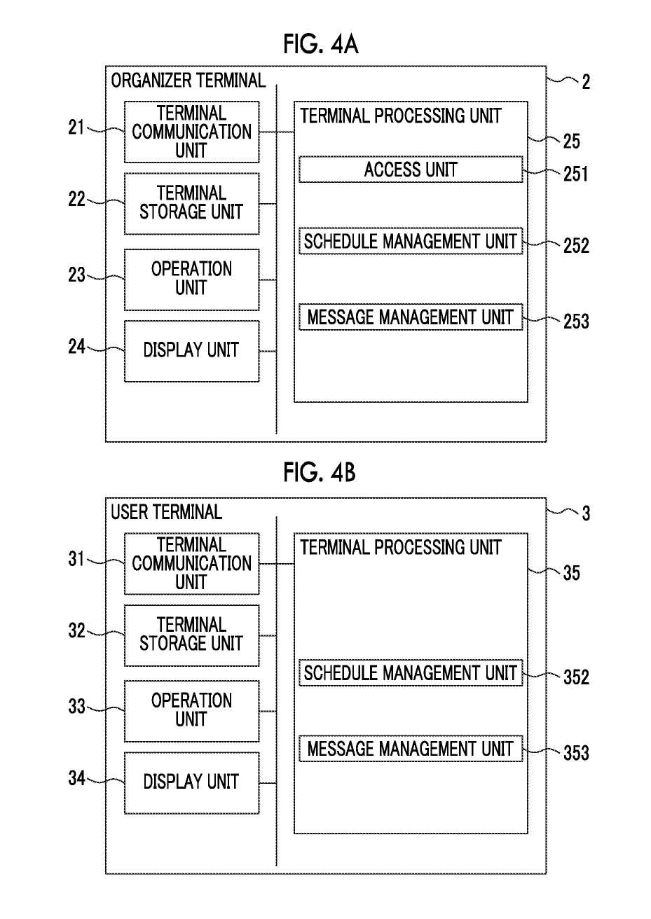

FIG. 4A is a view that shows an example of the schematic configuration of the organizer terminal 2.

The organizer terminal 2 includes a terminal communication unit 21, a terminal storage unit 22, an operation unit 23, a display unit 24, a terminal processing unit 25, and the like. The organizing user is a person in charge who holds an event that a plurality of users are planned to attend. The organizing user may be a user who has become a candidate for the organizing user or may be a user selected freely. The event means an entertainment or event that is held at a facility. The event is, for example, a company trip, a New Year party, a year-end party, a barbecue, a banquet, a social gathering, a class reunion, a golf competition, or the like. A multifunctional mobile phone (so-called smartphone) is assumed as the organizer terminal 2; however, the organizer terminal 2 is not limited to the multifunctional mobile phone. The organizer terminal 2 may be any terminal to which the invention is applicable, and may be, for example, a mobile phone (so-called feature phone), a mobile information terminal (personal digital assistant (PDA)), a tablet PC, a personal computer, or the like.

The terminal communication unit 21 includes a communication interface circuit including an antenna having a predetermined frequency band as a sensitive band. The terminal communication unit 21 connects the organizer terminal 2 to the Internet 5. The terminal communication unit 21 transmits data, supplied from the terminal processing unit 25, to the server 4, or the like. The terminal communication unit 21 supplies data, received from the server 4, or the like, to the terminal processing unit 25.

The terminal storage unit 22 includes, for example, at least any one of a semiconductor memory, a magnetic disk drive and an optical disk drive. The terminal storage unit 22 stores an operating system program, a driver program, an application program, data, and the like, that are used for processing in the terminal processing unit 25. For example, the terminal storage unit 22 stores an input device driver program that controls the operation unit 23, an output device driver program that controls the display unit 24, and the like, as the driver program. The terminal storage unit 22 stores a program that executes transmission and reception of a message, and the like, as the application program. The terminal storage unit 22 stores transmitted and received messages and associated data as the data. Furthermore, the terminal storage unit 22 may temporarily store temporary data associated with predetermined processing.

The operation unit 23 may be any device as long as the organizer terminal 2 is operable by using the operation unit 23, and is, for example, a touch panel, a keyboard, or the like. The organizing user is able to input characters, numerics, and the like, with the use of the operation unit 23. As the operation unit 23 is operated by the organizing user, the operation unit 23 generates a signal corresponding to the operation. The generated signal is supplied to the terminal processing unit 25 as a command of the organizing user.

The display unit 24 may be any device as long as the display unit 24 is able to display a character string, an image, and the like. The display unit 24 may be, for example, a liquid crystal display, an electro-luminescence (EL) display, or the like. The display unit 24 displays a transmitted or received message, or the like, supplied from the terminal processing unit 25.

The terminal processing unit 25 includes an access unit 251, a schedule management unit 252, a message management unit 253, and the like. The terminal processing unit 25 is to generally control the overall operations of the organizer terminal 2. The terminal processing unit 25 consists of one or plurality of processors and their peripheral circuit (for example, central processing unit (CPU)). The terminal processing unit 25 controls the operations of the terminal communication unit 21, display unit 24, and the like, such that the programs stored in the terminal storage unit 22 are executed in an appropriate procedure in response to operation of the operation unit 23, or the like. The terminal processing unit 25 executes processing on the basis of the programs (the operating system program, the driver program, the application program, and the like) that are stored in the terminal storage unit 22. The terminal processing unit 25 is able to execute a plurality of programs (application programs, or the like) in parallel.

The access unit 251, the schedule management unit 252 and the message management unit 253 are functional modules that are implemented by programs that are executed by the processor(s) of the terminal processing unit 25. Alternatively, the access unit 251, the schedule management unit 252 and the message management unit 253 may be implemented in the organizer terminal 2 as firmware.

The access unit 251 accesses the world wide web (web), and acquires and displays display data. That is, the access unit 251 transmits input, selection, or the like, regarding an event to the server 4 via the terminal communication unit 21 in response to a command from the organizing user. The access unit 251 receives display data corresponding to processing results for input, selection, or the like, regarding the event from the server 4 via the terminal communication unit 21, and displays a page on the display unit 24 on the basis of the received display data.

The schedule management unit 252 manages a schedule with the use of an exclusive schedule management application downloaded in advance. The schedule management unit 252 displays the calendar on the display unit 24, and displays registered plans, a plurality of candidate dates and times of an event or a date and time for holding an event on the calendar on the basis of image information received from the server 4.

The message management unit 253 transmits or receives a message via the terminal communication unit 21.

FIG. 4B is a view that shows an example of the schematic configuration of the user terminal 3.

The user terminal 3 includes a terminal communication unit 31, a terminal storage unit 32, an operation unit 33, a display unit 34, a terminal processing unit 35, and the like. The user terminal 3 is any one of terminals of the plurality of convened users who are convened to attend an event. A multi-functional mobile phone is assumed as the user terminal 3; however, the user terminal 3 is not limited to the multi-functional mobile phone. The user terminal 3 may be any terminal to which the invention is applicable. The user terminal 3 may be, for example, a mobile phone, a mobile information terminal, a tablet PC, a personal computer, or the like.

The terminal communication unit 31, terminal storage unit 32, operation unit 33, display unit 34 and terminal processing unit 35 of the user terminal 3 are similar to the terminal communication unit 21, terminal storage unit 22, operation unit 23, display unit 24 and terminal processing unit 25 of the organizer terminal 2. The terminal processing unit 35 includes a schedule management unit 352 and a message management unit 353; however, the terminal processing unit 35 does not include an access unit 351.

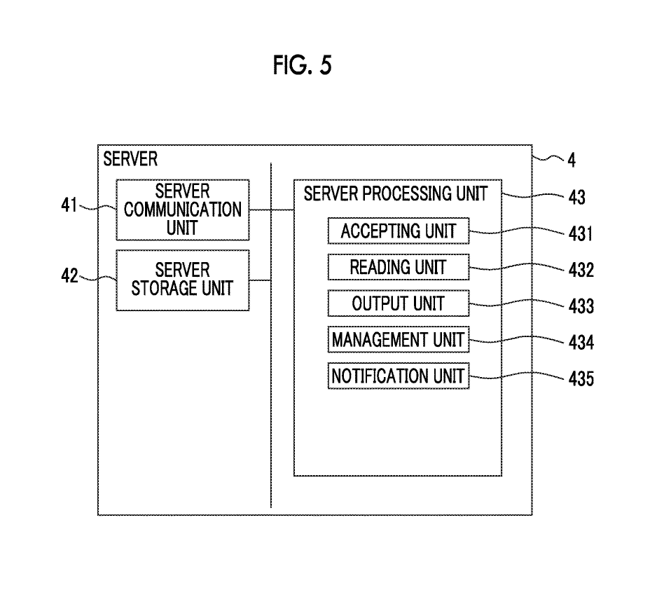

FIG. 5 is a view that shows an example of the schematic configuration of the server 4.

The server 4 includes a server communication unit 41, a server storage unit 42 and a server processing unit 43. The server 4 consists of a standalone device.

The server 4 may consist of a plurality of devices.

The server communication unit 41 includes a communication interface circuit for transmitting or receiving data via the Internet 5. The server communication unit 41 communicates with the organizer terminal 2 or the user terminal 3.

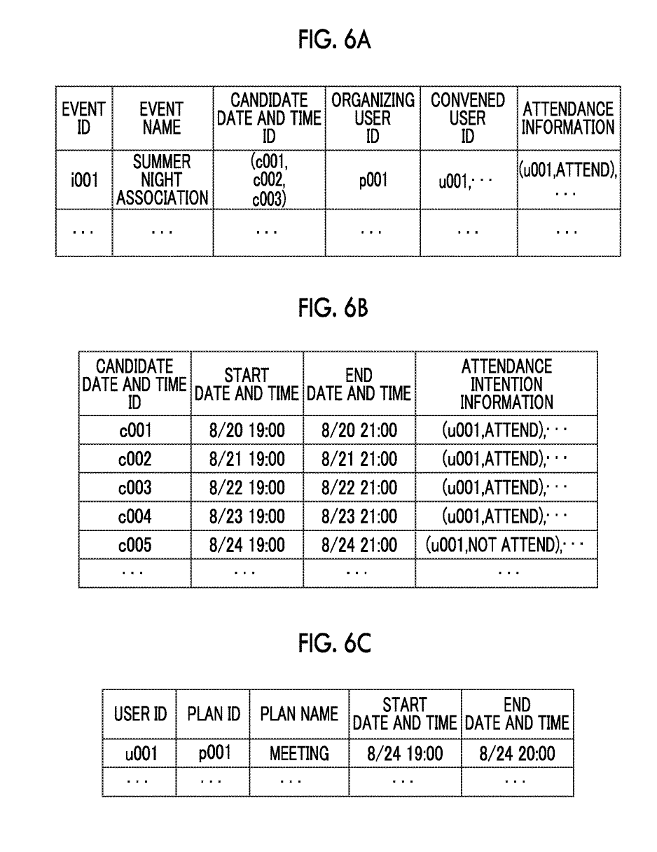

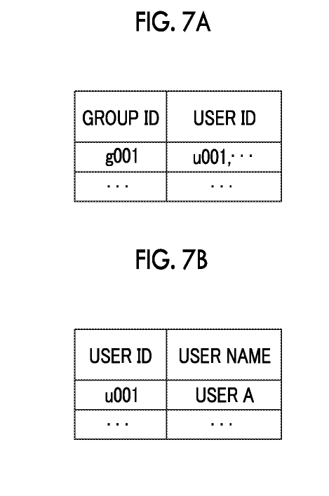

The server storage unit 42 includes, for example, at least any one of a magnetic tape drive, a magnetic disk drive or an optical disk drive. The server storage unit 42 stores an operating system program, a driver program, an application program, data, and the like, that are used for processing in the server processing unit 43. The server storage unit 42 stores an event management table (FIG. 6A), a candidate date and time management table (FIG. 6B) and a plan management table (FIG. 6C) as the data. The server storage unit 42 stores a group management table (FIG. 7A) and a user management table (FIG. 7B). as the data. The server storage unit 42 further includes a buffer for temporarily storing temporary data regarding predetermined processing.

The server processing unit 43 includes an accepting unit 431, a reading unit 432, an output unit 433, a management unit 434, a notification unit 435, and the like. The server processing unit 43 generally controls the overall operations of the server 4. The server processing unit 43 consists of one or plurality of processors and their peripheral circuit (for example, CPU). The server processing unit 43 controls the operations of the server communication unit 41, and the like, in an appropriate procedure on the basis of the programs (the operating system program, the driver program, the application program, and the like) that are stored in the server storage unit 42. In addition, the server processing unit 43 may execute a plurality of programs (application programs, or the like) in parallel.

The accepting unit 431, the reading unit 432, the output unit 433, the management unit 434 and the notification unit 435 are functional modules that are implemented by programs that are executed by the processor(s) of the server processing unit 43. The accepting unit 431, the reading unit 432, the output unit 433, the management unit 434 and the notification unit 435 may be implemented in the server 4 as firmware.

The accepting unit 431 accepts a setting received from the organizer terminal 2 or the user terminal 3 via the server communication unit 41. The details of processing of the accepting unit 431 will be described later.

The reading unit 432 reads data that are stored in the server storage unit 42. The details of processing of the reading unit 432 will be described later.

The output unit 433 outputs page information to the organizer terminal 2 or the user terminal 3 by transmitting the page information to the organizer terminal 2 or the user terminal 3 via the server communication unit 41. The details of processing of the output unit 433 will be described later.

The management unit 434 manages schedules. The details of processing of the management unit 434 will be described later.

The notification unit 435 provides a request to set candidate dates and times, at which the convened user can attend, or a message of a request to fix attendance to the user terminal 3 by transmitting a request to set candidate dates and times, at which the convened user can attend, or a message of a request to fix attendance to the user terminal 3 via the server communication unit 41. The details of processing of the notification unit 435 will be described later.

FIG. 6A is a view that shows an example of the data structure of the event management table.

The data structure shown in FIG. 6A provides a plurality of series of data associated with event IDs, which are stored in the server storage unit 42. An event ID is information for identifying an event. A series of data includes, for example, an event name, a candidate date and time ID, an organizing user ID, a convened user ID, attendance information, and the like. The above-described series of data is one example, and may include another piece of information regarding an event. A candidate date and time ID is information for identifying a candidate date and time of an event. An organizing user ID is information for identifying an organizing user who holds an event. A convened user ID is information for identifying a convened user who is convened to attend an event by an organizing user. Attendance information includes the ID of a convened user and attendance information set by the convened user. Attendance information indicates, for example, any one of attend, suspend and not attend.

FIG. 6B is a view that shows an example of the data structure of the candidate date and time management table.

The candidate date and time management table is stored for each event. The data structure shown in FIG. 6B provides a plurality of series of data associated with candidate date and time IDs, which are stored in the server storage unit 42. A series of data includes, for example, a start date and time of a candidate date and time, an end date and time of the candidate date and time, attendance intention information, and the like. The above-described series of data is one example, and may include another piece of information regarding a candidate date and time. A candidate date and time is a candidate schedule at which an event is held. For example, a candidate start date and time and end date and time, at which an event is held, is specified as a candidate date and time. Only a candidate start date and time at which an event is held may be specified as a candidate date and time. Only a candidate date on which an event is held may be specified as a candidate date and time. A period until a predetermined time elapses from a candidate start date and time at which an event is held may be specified as a candidate date and time. The attendance intention information contains the ID of a convened user and attendance information set by the convened user. Attendance information indicates, for example, any one of attend, suspend and not attend. A candidate date and time corresponding to a candidate date and time ID associated with attendance information that indicates attend is a candidate date and time at which a convened user can attend.

FIG. 6C is a view that shows an example of the data structure of the plan management table.

The data structure shown in FIG. 6C provides a plurality of series of data associated with user IDs, which are stored in the server storage unit 42. User IDs include an organizing user ID and convened user IDs. A series of data includes, for example, a plan ID, a plan name, a start date and time of a plan, an end date and time of the plan, and the like. The above-described series of data is one example, and may include another piece of information regarding a plan. A plan ID is information for identifying a plan of an organizing user or convened user. A plan is data in which a user's event or activity is determined in advance and that are managed by a schedule management application.

FIG. 7A is a view that shows an example of the data structure of the group management table.

The group management table is stored for each group. A group indicates an organization to which an organizing user and convened users belong. The data structure shown in FIG. 7A provides a plurality of series of data associated with group IDs, which are stored in the server storage unit 42. A series of data includes, for example, user IDs, and the like. The above-described series of data is one example, and may include another piece of information regarding a group. A group ID is information for identifying a group to which an organizing user or a convened user belongs. A user ID is information for identifying an organizing user or a convened user.

FIG. 7B is a view that shows an example of the data structure of the user management table.

The data structure shown in FIG. 7B provides a plurality of series of data associated with user IDs, which are stored in the server storage unit 42. A series of data includes, for example, a user name, and the like. The above-described series of data is one example, and may include another piece of information regarding a user. A user name is the name of an organizing user or convened user.

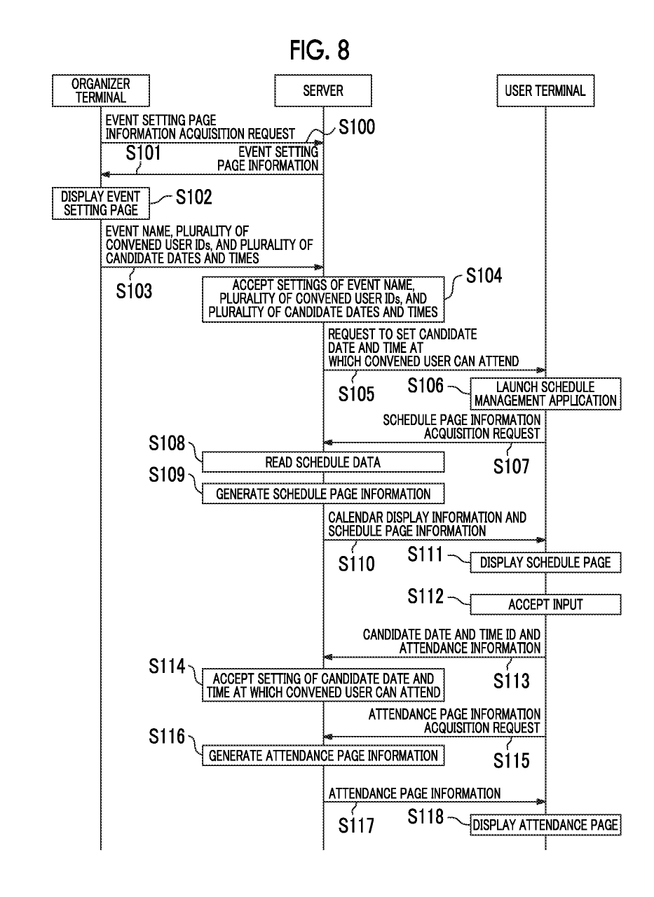

FIG. 8 is a view that shows an example of the operation sequence of the process of determining candidate dates and times by the schedule management system 1.

The operation sequence that will be described below is executed mainly by the terminal processing unit 25, the terminal processing unit 35 and the server processing unit 43 on the basis of programs that are stored in the terminal storage unit 22, the terminal storage unit 32 and the server storage unit 42 in advance in cooperation with the elements of the organizer terminal 2, user terminal 3 and server 4.

Initially, in response to operation of the organizing user, the access unit 251 of the organizer terminal 2 logs into the server 4, and transmits an event setting page information acquisition request to the server 4 (step S100). The event setting page information acquisition request is a request for acquiring event setting page information. The event setting page information is information for displaying an event setting page (described later).

Subsequently, as the output unit 433 of the server 4 receives the event setting page information acquisition request from the organizer terminal 2, the output unit 433 outputs event setting page information to the organizer terminal 2 (step S101). The output unit 433 consults the user management table, and identifies the user ID and user name of the organizing user who has transmitted the event setting page information acquisition request. The output unit 433 consults the group management table and the user management table, and identifies the user ID and user name of each user who belongs to the same group to which the identified organizing user belongs. The output unit 433 outputs, to the organizer terminal 2, event setting page information containing the user name of the identified organizing user and the user ID and user name of each user who belongs to the same group.

Subsequently, as the access unit 251 of the organizer terminal 2 receives the event setting page information from the server 4, the access unit 251 displays the event setting page on the display unit 24 on the basis of the received event setting page information (step S102).

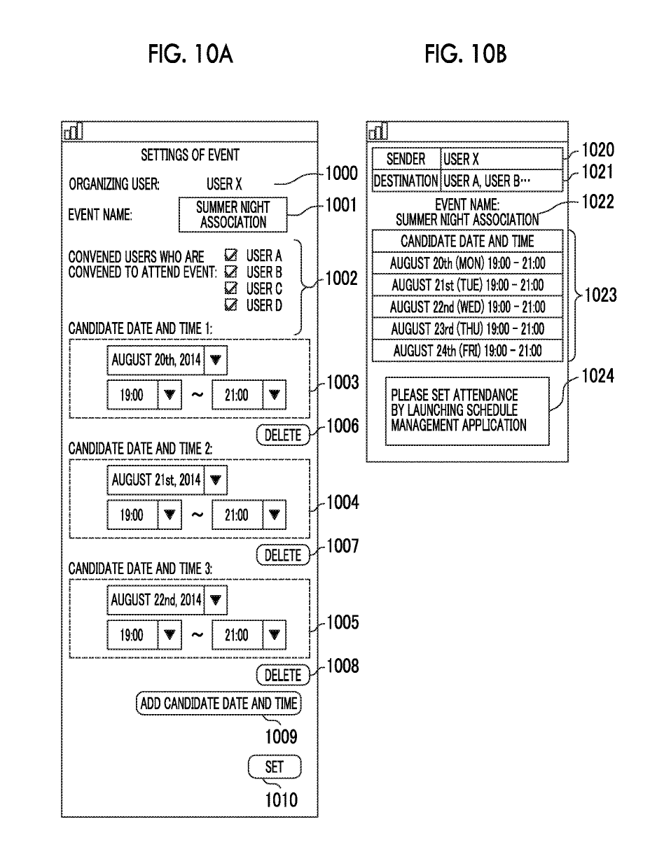

FIG. 10A is a view that shows an example of the event setting page that is displayed on the organizer terminal 2.

An organizing user name 1000, an input box 1001, check boxes 1002, pull-down menus 1003 to 1005, delete buttons 1006 to 1008, an add button 1009 and a setup button 1010 are displayed on the event setting page.

The organizing user name 1000 is the user name of an organizing user. The input box 1001 is an input area for inputting an event name. The check boxes 1002 are selection areas for selecting a plurality of convened users that are convened to attend an event. The user names of users who belong to the same group to which the organizing user belongs are displayed next to the check boxes 1002 so as to be selectable. The pull-down menus 1003 to 1005 are areas for selecting a candidate date and time. A start date and time and an end date and time are displayed as a candidate date and time in each of the pull-down menus 1003 to 1005 such that the start date and time and the end date and time are allowed to be specified. The delete buttons 1006 to 1008 are respectively buttons for deleting the pull-down menus 1003 to 1005. The add button 1009 is a button for adding a new pull-down menu for selecting a candidate date and time. The setup button 1010 is a button for allowing an organizing user to set convened users and candidate dates and times.

As the organizing user depresses the setup button 1010 with the use of the operation unit 23, the access unit 251 transmits, to the server 4, the event name, the convened user ID of each convened user and each candidate date and time, specified on the event setting page (step S103).

As the accepting unit 431 of the server 4 receives the event name, each convened user ID and each candidate date and time from the organizer terminal 2, the accepting unit 431 accepts the received settings of the event name, each convened user ID and each candidate date and time (step S104). That is, the accepting unit 431 assigns a new candidate date and time ID to each of the accepted candidate dates and times, and stores the start date and time and end date and time of each of the received candidate dates and times in the candidate date and time management table in association with the candidate date and time ID. The accepting unit 431 consults the user management table, and identifies the user ID of the user who has transmitted the event setting page information acquisition request as the organizing user ID. The accepting unit 431 generates a new event ID, and stores the received event name, each convened user ID, each candidate date and time ID and the identified organizing user ID in the event management table in association with one another.

Subsequently, the notification unit 435 provides a message of a request to set a candidate date and time, at which the convened user can attend, to the user terminal 3 of each convened user (step S105). As the message management unit 353 of the user terminal 3 receives the message from the server 4, the message management unit 353 displays the received message on the display unit 34.

FIG. 10B is a view that shows an example of the message that is displayed on the user terminal 3.

The message contains a sender 1020, a destination 1021, an event name 1022, candidate dates and times 1023 and request text 1024 showing the details of a request. The user name of an organizing user is displayed as the sender 1020. The convened user name of each convened user is displayed as the destination 1021. The event name input in the input box 1001 of FIG. 10A is displayed as the event name 1022. The candidate dates and times respectively input in the pull-down menus 1003 to 1005 of FIG. 10A are displayed as the candidate dates and times 1023.

Subsequently, the schedule management unit 352 launches the schedule management application in response to operation of the convened user (step S106).

Subsequently, the schedule management unit 352 transmits a calendar display information acquisition request and a schedule page information acquisition request (step S107). The calendar display information acquisition request is a request for acquiring calendar display information. The schedule page information acquisition request is a request for acquiring schedule page information.

As the management unit 434 of the server 4 receives the calendar display information acquisition request and the schedule page information acquisition request from the user terminal 3, the management unit 434 reads schedule data corresponding to each candidate date and time from the plan management table for each convened user (step S108). Initially, the management unit 434 consults the event management table and the candidate date and time management table, and identifies the start date and time and end date and time of each candidate date and time of an event that the accessed convened user has been convened to attend. The management unit 434 consults the plan management table, and compiles the number of convened users having plans in at least part of the start date and time to end date and time of each candidate date and time.

Subsequently, the management unit 434 generates schedule page information on the basis of the compiled number of convened users having plans (step S109). The schedule page information is data for displaying a plurality of candidate dates and times on a page such that candidate dates and times at which the number of convened users having plans is small and candidate dates and times at which the number of convened users having plans is large are in distinction from each other. That is, the schedule page information contains a display property that specifies the color, font, size, or the like, of text for each candidate date and time. The management unit 434 specifies the display property such that a candidate date and time is more highlighted as the number of convened users having plans at the candidate date and time reduces, and specifies the display property such that a candidate date and time becomes inconspicuous as the number of convened users having plans at the candidate date and time increases. For this reason, initially, the management unit 434 provides a predetermined first threshold and a second threshold larger than the first threshold, and then compares the number of convened users having plans at a candidate date and time with the first threshold and the second threshold. The number of thresholds is not limited to two, and may be one or three or more.

When the number of convened users having plans at a candidate date and time is smaller than the first threshold, the management unit 434 specifies the display property of the candidate date and time icon such that the candidate date and time icon is highlighted. For example, it is assumed that the number of convened users having plans is such that one on August 20th, one on August 23rd and one on August 24th. In this case, the number of convened users having plans on each of August 20th, August 23rd, and August 24th is one, and is smaller than the first threshold (for example, three). For this reason, the management unit 434 specifies the display properties of the candidate date and time icons on August 20th, August 23rd, and August 24th such that the candidate date and time icons are highlighted (for example, displayed in deep red). The display property for highlighting may be a size larger than a predetermined value, boldface type or Gothic font.

On the other hand, when the number of convened users having plans at a candidate date and time is larger than or equal to the first threshold and smaller than or equal to the second threshold, the management unit 434 specifies the display property of the candidate date and time icon such that the candidate date and time icon is not highlighted. For example, it is assumed that the number of convened users having plans is five on August 21st. In this case, the number of convened users having plans on August 21st is five, and is larger than or equal to the first threshold (for example, three) and smaller than or equal to the second threshold (for example, seven). For this reason, the management unit 434 specifies the display property of the candidate date and time icon on August 21st such that the candidate date and time icon on August 21st is not highlighted (for example, displayed in red not deep or light).

Furthermore, when the number of convened users having plans on a candidate date and time is larger than the second threshold, the management unit 434 specifies the display property of the candidate date and time icon such that the candidate date and time icon is inconspicuously displayed. For example, it is assumed that the number of convened users having plans is nine on August 22nd. In this case, the number of convened users having plans on August 22nd is nine, and is larger than the second threshold (for example, seven). For this reason, the management unit 434 specifies the display property of the candidate date and time icon on August 22nd such that the candidate date and time icon on August 22nd is inconspicuously displayed (for example, displayed in light red). The display property for inconspicuously displaying may be a size smaller than a predetermined value, faint face or Mincho font.

In this way, the management unit 434 generates schedule page information containing the display property specified for each candidate date and time.

The management unit 434 consults the plan management table, and identifies the plans of the convened user who has transmitted the calendar display information acquisition request and the schedule page information acquisition request. The management unit 434 generates calendar display information containing the plans of the identified convened user. The calendar display information is display data for displaying plans in calendar form.

The output unit 433 transmits the generated calendar display information and schedule page information to the user terminal 3 (step S110).

As the schedule management unit 352 of the user terminal 3 receives the calendar display information and the schedule page information from the server 4, the schedule management unit 352 displays a schedule page on the display unit 34 on the basis of the received calendar display information and schedule page information (step S111). Initially, the schedule management unit 352 displays the plans of the convened user on the calendar in accordance with the received calendar display information. In addition, the schedule management unit 352 displays each candidate date and time icon on the calendar in accordance with the display properties contained in the received schedule page information.

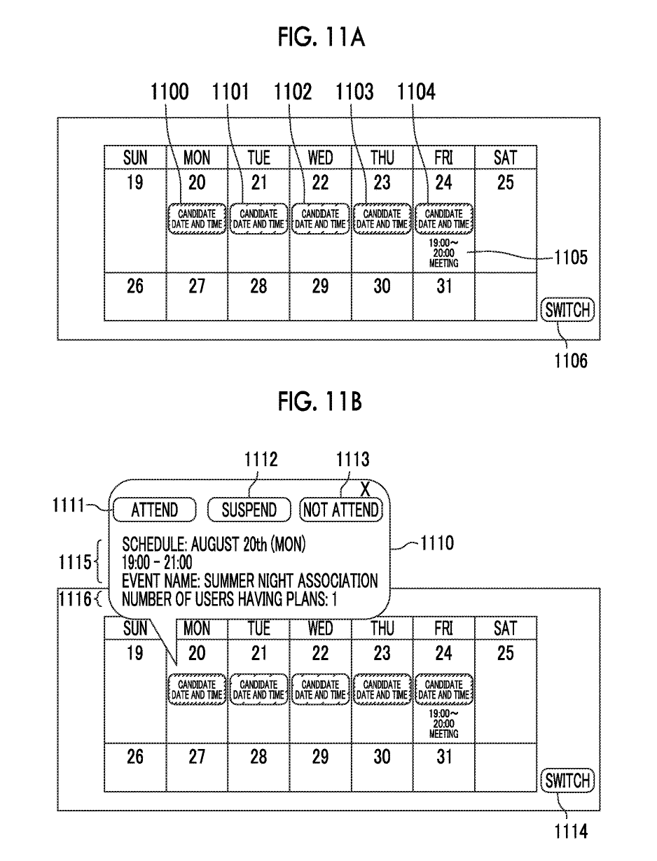

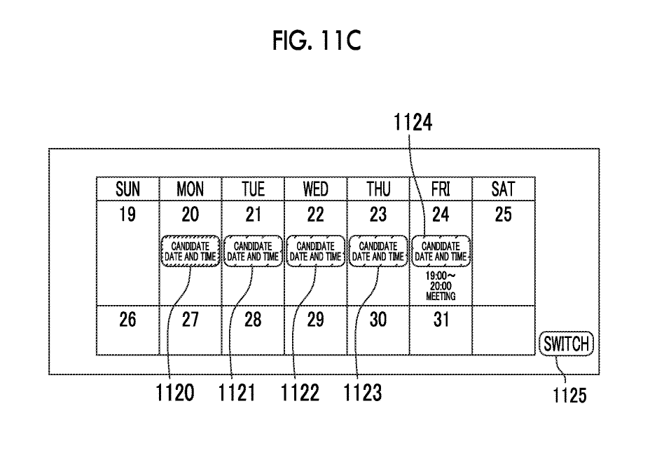

FIG. 11A is a view that shows an example of the schedule page that is displayed on the user terminal 3.

Candidate date and time icons 1100 to 1104, a plan 1105 of a convened user, and a switch button 1106 are displayed on the schedule page.

The candidate date and time icons 1100 to 1104 are displayed in accordance with the corresponding display properties contained in the schedule page information. The plan 1105 of the convened user is displayed in accordance with the calendar display information. The switch button 1106 is a button for switching from the schedule page to the attendance page.

In this way, the schedule management unit 352 that has received the schedule page information transmitted from the server 4 displays the candidate dates and times distinctly step-by-step (gradationally) on the basis of the number of convened users having plans. Therefore, each convened user is allowed to estimate a major candidate among the plurality of candidate dates and times displayed on the user terminal 3.

Subsequently, the schedule management unit 352 accepts input of a candidate date and time at which the convened user can attend (step S112). When any one of the candidate date and time icons has been specified by the convened user, the schedule management unit 352 displays an attendance setting window regarding the corresponding candidate date and time.

FIG. 11B is a view that shows an example of an attendance setting window 1110 that is displayed on the user terminal 3.

An attend button 1111, a suspend button 1112, a not-attend button 1113, a switch button 1114, information 1115 regarding an event, and the number 1116 of convened users having plans at the candidate date and time are displayed on the attendance setting window 1110.

Subsequently, as any one of the attend button 1111, the suspend button 1112 and the not-attend button 1113 is depressed in response to operation of the convened user, the schedule management unit 352 transmits the candidate date and time ID of the selected candidate date and time and attendance information corresponding to the depressed button to the server 4 (step S113).

As the accepting unit 431 of the server 4 receives the candidate date and time ID and the attendance information from the user terminal 3, the accepting unit 431 accepts the settings of the candidate date and time ID and attendance information (step S114). That is, as the accepting unit 431 receives the candidate date and time ID and the attendance information from the user terminal 3, the accepting unit 431 stores the convened user ID of the convened user who has transmitted the attendance information and the received attendance information in the candidate date and time management table in association with the received candidate date and time ID.

Subsequently, as the switch button 1114 on the schedule page is depressed in response to operation of the convened user, the access unit 351 transmits an attendance page information acquisition request to the server 4 (step S115). The attendance page information acquisition request is a request for acquiring attendance page information.

As the management unit 434 of the server 4 receives the attendance page information acquisition request from the user terminal 3, the management unit 434 generates attendance page information on the basis of the candidate dates and times at which the convened user can attend and that have been accepted in step S114 (step S116). The management unit 434 specifies the display property of each candidate date and time such that candidate dates and times at which the convened user can attend and the other candidate dates and times are displayed in distinction from each other. For example, when only the candidate date and time on August 20th is set as attend, the management unit 434 specifies the display property of the candidate date and time on August 20th such that the candidate date and time on August 20th is highlighted (for example, displayed in deep red). The display property for highlighting may be a size larger than a predetermined value, boldface type or Gothic font. When the candidate dates and times on August 21st to August 24th are not set as attend, the management unit 434 specifies the display properties of the candidate dates and times on August 21st to August 24th such that the candidate dates and times on August 21st to August 24th are inconspicuously displayed (for example, displayed in light red). The display property for inconspicuously displaying may be a size smaller than a predetermined value, faint face or Mincho font. In this way, the management unit 434 generates attendance page information containing the display property specified for each candidate date and time.

Subsequently, the output unit 433 transmits the generated attendance page information to the user terminal 3 (step S117).

Subsequently, as the schedule management unit 352 receives the attendance page information from the server 4, the schedule management unit 352 displays the attendance page on the display unit 34 on the basis of the received attendance page information (step S118). The schedule management unit 352 displays the icon of each candidate date and time on the calendar in accordance with the display properties contained in the received attendance page information.

FIG. 11C is a view that shows an example of the attendance page that is displayed on the user terminal 3.

Candidate date and time icons 1120 to 1124 and a switch button 1125 are displayed on the attendance page.

Thus, the convened user is allowed to compare the candidate dates and times at which the convened user can attend with the candidate dates and times at which the number of convened users having plans is small and the candidate dates and times at which the number of convened users having plans is large.

As the switch button 1125 is depressed, the schedule management unit 352 transmits the schedule page information acquisition request to the server 4 as in the case of the process of step S107. In this case, the server 4 executes similar processes to step S108 to step S110, and the schedule management unit 352 of the user terminal 3 displays the schedule page of FIG. 11A on the display unit 34 again.

The operation sequence of the process of determining candidate dates and times by the schedule management system 1 ends. The schedule management system 1 may execute the processes of step S105 to step S118 on the organizer terminal 2.

In this way, the schedule management unit 352 that has received the schedule page information transmitted from the server 4 displays the candidate date and time icons 1100 to 1104 such that the candidate dates and times at which the number of convened users having plans is small and the candidate dates and times at which the number of convened users having plans is large are in distinction from each other. Thus, each convened user is able to assume a major candidate among the plurality of candidate dates and times.

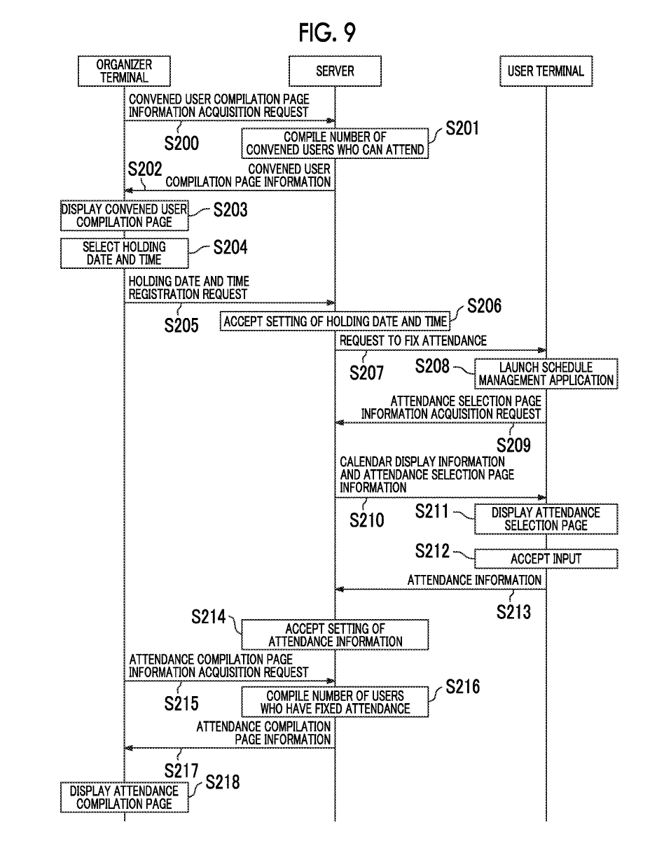

FIG. 9 is a view that shows an example of the operation sequence of the process of determining a holding date and time by the schedule management system 1.

The sequence that will be described below is executed mainly by the terminal processing unit 25, the terminal processing unit 35 and the server processing unit 43 on the basis of programs that are stored in the terminal storage unit 22, the terminal storage unit 32 and the server storage unit 42 in advance in cooperation with the elements of the organizer terminal 2, user terminal 3 and server 4.

Initially, in response to operation of the organizing user, the access unit 251 of the organizer terminal 2 logs into the server 4, and transmits a convened user compilation page information acquisition request to the server 4 (step S200). The convened user compilation page information acquisition request is a request for acquiring convened user compilation page information. The convened user compilation page information acquisition request contains the event ID of an event for which the organizing user requires compilation. The convened user compilation page information is information for displaying convened user compilation page (described later).

As the management unit 434 of the server 4 receives the convened user compilation page information acquisition request from the organizer terminal 2, the management unit 434 compiles the number of convened users who can attend (step S201). Initially, the management unit 434 identifies the event ID that is contained in the convened user compilation page information acquisition request. The management unit 434 consults the event management table and the candidate date and time management table, and compiles the attendance information of each convened user for each candidate date and time of the event corresponding to the identified event ID. The management unit 434 identifies an event name by consulting the event management table, identifies each candidate date and time and the ID of each candidate date and time by consulting the event management table and the candidate date and time management table, and identifies the attendance information of each convened user for each identified candidate date and time.

Subsequently, the output unit 433 outputs the convened user compilation page information containing the compiled and identified pieces of information to the organizer terminal 2 (step S202).

As the access unit 251 of the organizer terminal 2 receives the convened user compilation page information from the server 4, the access unit 251 displays the convened user compilation page on the display unit 24 on the basis of the received convened user compilation page information (step S203).

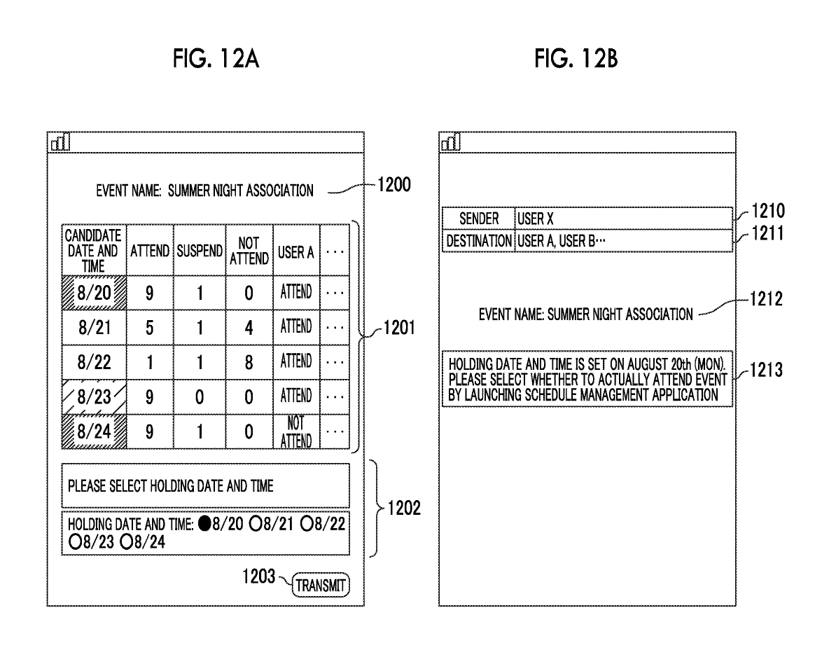

FIG. 12A is a view that shows an example of the convened user compilation page that is displayed on the organizer terminal 2.

An event name 1200, compiled results 1201 of convened users, radio buttons 1202 for selecting a holding date and time, a transmit button 1203, and the like, are displayed on the convened user compilation page.

The event name contained in the convened user compilation page information is displayed as the event name 1200. The attendance information compiled for each candidate date and time and the attendance information of each convened user, contained in the convened user compilation page information, are displayed as the compiled results 1201. The radio buttons 1202 are buttons for selecting a holding date and time, and the candidate dates and times contained in the convened user compilation page information are displayed as selectable dates and times for holding the event. The transmit button 1203 is a button for transmitting a holding date and time selected by the radio buttons 1202.

The organizing user selects a holding date and time from among the plurality of candidate dates and times with the use of the operation unit 23 (step S204).

As the transmit button 1203 is depressed in response to operation of the convened user, the access unit 251 transmits a holding date and time registration request to the server 4 (step S205). The holding date and time registration request contains the candidate date and time ID of the candidate date and time selected as the holding date and time with the use of the radio buttons 1202 for selecting a holding date and time on the convened user compilation page.

As the accepting unit 431 of the server 4 receives the holding date and time registration request, the accepting unit 431 accepts the setting of the holding date and time (step S206). The accepting unit 431 identifies the candidate date and time ID contained in the received holding date and time registration request. The accepting unit 431 consults the event management table, and identifies the user ID of each convened user convened to the event of which the setting of the holding date and time has been accepted. The accepting unit 431 stores the accepted holding date and time in the plan management table as a new plan of each convened user in association with the start date and time and end date and time, associated with the identified candidate date and time ID, and the event name. The accepting unit 431 deletes the candidate dates and times of the event for which the setting of the holding date and time has been accepted, from the event management table and the candidate date and time management table.

The notification unit 435 provides a message of a request to fix attendance at the accepted holding date and time to the user terminal 3 of each convened user (step S207). As the message management unit 353 of the user terminal 3 receives the message from the server 4, the message management unit 353 displays the received message on the display unit 34.

FIG. 12B is a view that shows an example of the message that is displayed on the user terminal 3.

The message contains a sender 1210, a destination 1211, an event name 1212 and a request 1213 to fix attendance. The sender 1210, the destination 1211 and the event name 1212 are similar to the sender 1020, the destination 1021 and the event name 1022 in FIG. 10B, respectively.

Subsequently, the schedule management unit 352 launches the schedule management application in response to operation of the convened user (step S208).

Subsequently, the schedule management unit 352 transmits a calendar display information acquisition request and an attendance selection page information acquisition request (step S209). The attendance selection page information acquisition request is a request for acquiring attendance selection page information. The attendance selection page information is information for displaying an attendance selection page for selecting whether to actually attend the event at the date and time for holding the event.

As the management unit 434 of the server 4 receives the calendar display information acquisition request and the attendance selection page information acquisition request from the user terminal 3, the management unit 434 generates calendar display information and attendance selection page information. The calendar display information is similar to that generated in step S109 of FIG. 8. The output unit 433 outputs the generated calendar display information and attendance selection page information to the user terminal 3 (step S210).

As the schedule management unit 352 of the user terminal 3 receives the calendar display information and the attendance selection page information from the server 4, the schedule management unit 352 displays an attendance selection page on the display unit 34 on the basis of the received calendar display information and attendance selection page information (step S211). Initially, the schedule management unit 352 displays the plans of the convened user on the calendar in accordance with the received calendar display information. Subsequently, the schedule management unit 352 displays the accepted holding date and time on the calendar in accordance with the received attendance selection page information.

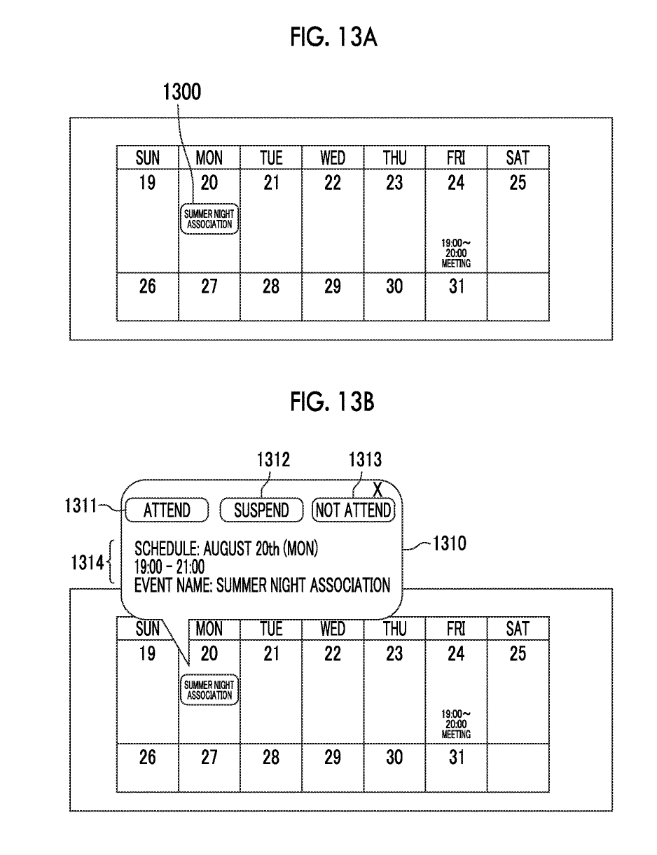

FIG. 13A is a view that shows an example of the attendance selection page that is displayed on the user terminal 3.

An icon 1300 that indicates that the event will be held is displayed on the attendance selection page in the plan display area of the holding date and time set from the organizer terminal 2.

Subsequently, the schedule management unit 352 accepts input of attendance for the event of which the holding date and time has been fixed (step S212). As the event icon 1300 of which the setting of the holding date and time has been accepted is specified in response to operation of the convened user, the schedule management unit 352 displays an attendance setting window 1310 for the specified event.

FIG. 13B is a view that shows an example of the attendance setting window 1310 that is displayed on the user terminal 3.

An attend button 1311, a suspend button 1312, a not-attend button 1313 and information 1314 regarding the event are displayed on the attendance setting window 1310.

Subsequently, as any one of the attend button 1311, the suspend button 1312 and the not-attend button 1313 is depressed in response to operation of the convened user, the schedule management unit 352 transmits attendance information corresponding to the depressed button to the server 4 (step S213).

As the accepting unit 431 of the server 4 receives the attendance information from the user terminal 3, the accepting unit 431 accepts the received setting of the attendance information (step S214). The accepting unit 431 stores the attendance information together with the convened user ID of the convened user who has transmitted the attendance information in the event management table in association with each other.

In response to operation of the organizing user, the access unit 251 of the organizer terminal 2 logs into the server 4, and transmits an attendance compilation page information acquisition request to the server 4 (step S215). The attendance compilation page information acquisition request is a request for acquiring attendance compilation page information. The attendance compilation page information is information for displaying an attendance compilation page. The attendance compilation page information contains the compiled results of the attendance information of each user who has fixed attendance and the attendance information of each user who has fixed attendance. The attendance compilation page information acquisition request contains the event ID of the event of which attendance is compiled.

As the management unit 434 of the server 4 receives the attendance compilation page information acquisition request, the management unit 434 compiles the number of users who have fixed attendance (step S216). The users who have fixed attendance include both the organizing user and the convened user. Initially, the management unit 434 identifies the event ID contained in the attendance compilation page information acquisition request. The management unit 434 reads the attendance information associated with the organizing user and convened users of the event corresponding to the identified event ID from the event management table, and compiles the attendance information of each user who has fixed attendance.

The output unit 433 outputs the attendance compilation page information to the organizer terminal 2 (step S217).

As the access unit 251 of the organizer terminal 2 receives the attendance compilation page information from the server 4, the access unit 251 displays the attendance compilation page on the display unit 24 on the basis of the received attendance compilation page information (step S218).

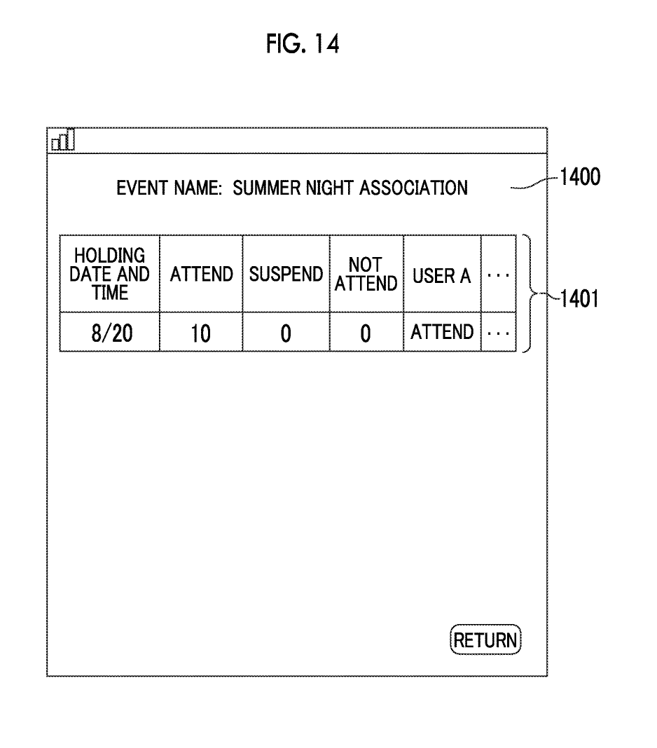

FIG. 14 is a view that shows an example of the attendance compilation page that is displayed on the organizer terminal 2.

An event name 1400, the compiled results of the attendance information of each user who has fixed attendance and attendance information 1401 of each user who has fixed attendance are displayed on the compilation page of the users who have fixed attendance. The event name 1400 is similar to the event name 1001 of FIG. 10A and FIG. 10B.

The operation sequence of fixing attendance by the schedule management system 1 ends. The schedule management system 1 may execute the processes of step S207 to step S214 on the organizer terminal 2.

In this way, the server 4 accepts the setting of the date and time for holding the event, and accepts the setting of the attendance information for the accepted holding date and time. Thus, it is possible to further accurately compile users who attend the event.

### OTHER EMBODIMENTS

The invention is not limited to the present embodiment. For example, when the candidate date and time icons 1120 to 1124 on the attendance page shown in FIG. 11C are specified, the schedule management unit 352 may display the corresponding attendance setting windows as well as the schedule page shown in FIG. 11B. In this case, the convened user may change the once set attendance information with the use of the operation unit 33. Thus, the convened user is allowed to set a schedule, at which the convened user can attend, on the attendance page, so the convenience of the convened user is improved.

When the user terminal 3 is a PC, the schedule management unit 352 may transmit an attendance page information acquisition request at the time when the mouse cursor is hovered over any one of the candidate dates and times on the schedule page. Similarly, the schedule management unit 352 may transmit a schedule page information acquisition request at the time when the mouse is hovered over any one of the candidate dates and times on the attendance page.

The schedule management unit 352 does not manage the schedule with the use of the schedule management application but may manage the schedule by accessing a web server. In this case, in step S106 of FIG. 8, the access unit 351 transmits a schedule page information acquisition request to the server 4 by accessing the server 4 that operates as a web server instead of launching the schedule management application. In step S208 of FIG. 9, the access unit 351 transmits an attendance page information acquisition request to the server 4 by accessing the server 4 that operates as a web server instead of launching the schedule management application. Thus, the convened user does not need to download the exclusive schedule management application in advance.

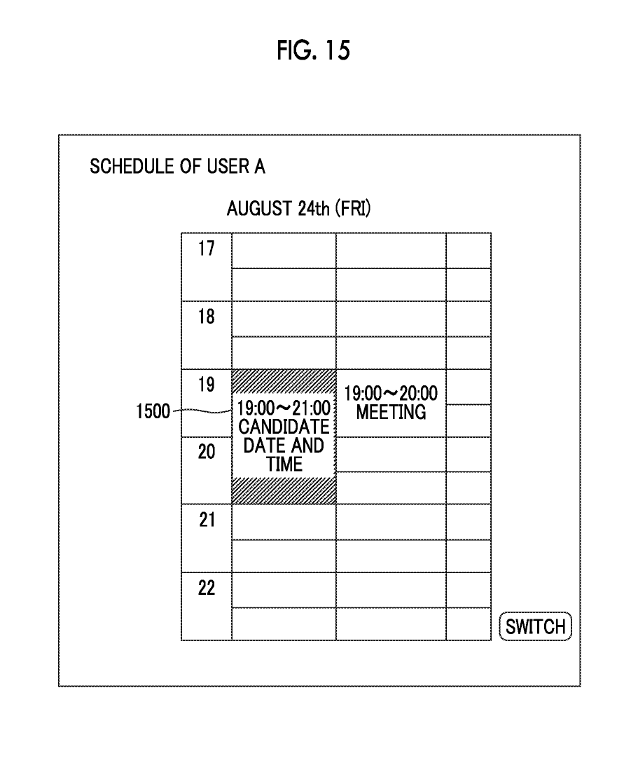

The schedule page or the attendance page may be a page on a day-to-day basis. FIG. 15 is a view that shows an example of the schedule page on a day-to-day basis, which is displayed on the user terminal 3.

The management unit 434 specifies the display property for a time period 1500 from the start time to end time of a candidate date and time, instead of a candidate date and time icon.

The management unit 434 may generate attendance schedule page information for displaying the plurality of candidate date and time icons on the schedule page together with attendance information icons of the corresponding candidate dates and times below the candidate date and time icons at the same time when the switch button on the schedule page has been depressed.

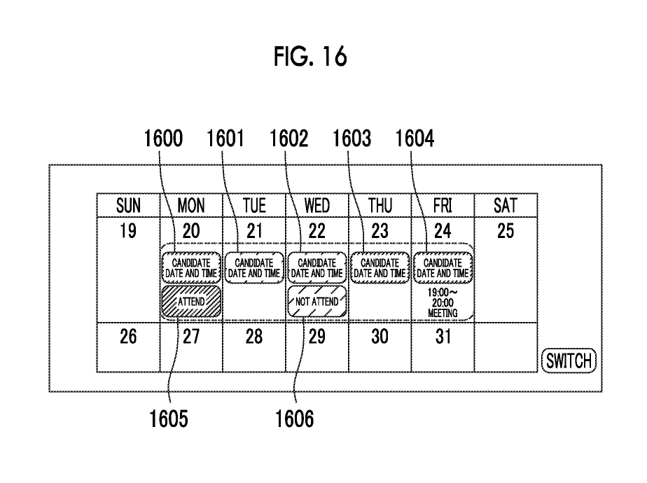

FIG. 16 is a view that shows an example of the attendance schedule page that is displayed on the user terminal 3.

Candidate date and time icons 1600 to 1604, and attendance information icons 1605, 1606 are displayed on the attendance schedule page at the same time.

Thus, the convened user is allowed to compare the candidate dates and times at which the convened user can attend with the candidate dates and times at which the number of convened users having plans is small and the candidate dates and times at which the number of convened users having plans is large. Therefore, the convened user is allowed to, where necessary, consider whether to change the date and time to attend an event even by changing his or her own plans.

The computer program for causing a computer to implement the functions of the terminal processing unit 25, terminal processing unit 35 and server processing unit 43 may be provided such that the computer program is stored in a computer-readable storage medium, such as a magnetic recording medium and an optical recording medium.

The output unit 433 may output each page sent to the user terminal 3 to the organizer terminal 2 upon a request from the organizer terminal 2. The accepting unit 431 of the server 4 may receive various information received from the user terminal 3 also from the organizer terminal 2. That is, the same processes as the user terminal 3 are applied to the organizer terminal 2 once the organizer terminal 2 sends the plurality of convened users and the plurality of candidate dates and times to the accepting unit 431 of the server 4. This will allow both the organizing user and the plurality of convened users to join the event in the same ground.

Persons skilled in the art understand that various modifications, replacements and changes are allowed to be added to the above-described embodiments without departing from the spirit and scope of the invention.

What is claimed is:

1. A control method for a server including a storage unit, the control method comprising:
storing schedule data in the storage unit, the schedule data indicating plans of each of a plurality of users;
accepting a setting of a plurality of convened users who are convened to attend an event and a setting of a plurality of candidate dates and times of the event from an organizer terminal of an organizing user who is one of the plurality of users;
reading the schedule data corresponding to the plurality of candidate dates and times from the storage unit for each of the plurality of convened users; and
outputting page information to user terminals of the plurality of convened users, the page information being information for displaying, on the user terminals of the plurality of convened users, a page containing the plurality of candidate dates and times such that the candidate dates and times at which the number of convened users having plans is small and the candidate dates and times at which the number of convened users having plans is large are in distinction from each other.

2. The control method according to claim 1, further comprising:
accepting a setting of candidate dates and times, at which the convened user can attend, from the user terminal of the convened user, which has received the output page information.

3. The control method according to claim 2, further comprising:
generating second page information on the basis of the setting of the candidate dates and times, at which the convened user can attend, the second page information being information for displaying the candidate dates and times such that the candidate dates and times, at which the convened user can attend, and the other candidate dates and times are in distinction from each other; and
outputting the second page information instead of the page information to the user terminal of the convened user, which has transmitted a request, in response to the request from the user terminal of the convened user.

4. The control method according to claim 2, further comprising:
generating the page information on the basis of the setting of the candidate dates and times at which the convened user can attend, the page information being information for displaying attendance information of the convened user at the corresponding candidate date and time at the same time.

5. The control method according to claim 2, further comprising:
compiling the number of convened users who can attend for each of the plurality of candidate dates and times of the event; and
outputting, to the organizer terminal, the compiled number of convened users who can attend for each of the plurality of candidate dates and times of the event.

6. The control method according to claim 1, further comprising:
accepting a setting of a date and time for holding the event from the organizer terminal; and
outputting third page information to the user terminals of the plurality of convened users, the third page information being information for selecting whether to actually attend the event at the date and time for holding the event.

7. The control method according to claim 6, further comprising:
accepting a setting of attendance information from the user terminal of the convened user, which has received the third page information; and
storing the attendance information in the storage unit in association with the convened user.

8. The control method according to claim 7, further comprising:
compiling the number of users who have fixed attendance for each of the plurality of candidate dates and times of the event; and
outputting, to the organizer terminal, the compiled number of users who attend and the compiled number of users who do not attend for each of the plurality of candidate dates and times of the event.

9. A server comprising:
a storage unit that stores schedule data indicating plans of each of a plurality of users;
an accepting unit that accepts a setting of a plurality of convened users who are convened to attend an event and a setting of a plurality of candidate dates and times of the event from an organizer terminal of an organizing user who is one of the plurality of users;
a reading unit that reads the schedule data corresponding to the plurality of candidate dates and times from the storage unit for each of the plurality of convened users; and
an output unit that outputs page information to user terminals of the plurality of convened users, the page information being information for displaying, on the user terminals of the plurality of convened users, a page containing the plurality of candidate dates and times such that the candidate dates and times at which the number of convened users having plans is small and the candidate dates and times at which the number of convened users having plans is large are in distinction from each other.

10. A non-transitory computer-readable storage medium storing a control program for a server including a storage unit, the control program causing the server to execute instructions for:
storing schedule data in the storage unit, the schedule data indicating plans of each of a plurality of users;
accepting a setting of a plurality of convened users who are convened to attend an event and a setting of a plurality of candidate dates and times of the event from an organizer terminal of an organizing user who is one of the plurality of users;
reading the schedule data corresponding to the plurality of candidate dates and times from the storage unit for each of the plurality of convened users; and
outputting page information to user terminals of the plurality of convened users, the page information being information for displaying, on the user terminals of the plurality of convened users, a page containing the plurality of candidate dates and times such that the candidate dates and times at which the number of convened users having plans is small and the candidate dates and times at which the number of convened users having plans is large are in distinction from each other.
